(19) United States
(12) Patent Application Publication
(10) Pub. No.: US 2026/0217441 A1
(43) Pub. Date: Jul. 30, 2026

(54) MOBILE FOOD TRANSPORTATION SYSTEM WITH HUMIDITY CONTROL

(71) Applicant: CFA Properties, Inc., Atlanta, GA (US)

(72) Inventor: Sedef Kavasogullari Josephson, Peachtree City, GA (US)

(21) Appl. No.: 19/456,061

(22) Filed: Jan. 22, 2026

Related U.S. Application Data
(60) Provisional application No. 63/750,558, filed on Jan. 28, 2025.

(51) Int. Cl. B65D 81/18; A45C 11/20

(52) U.S. Cl. CPC B65D 81/18; A45C 11/20; B65D 2205/00

(57) ABSTRACT

A mobile food transportation system with humidity control is provided. An example system includes a food item housing chamber structured to support one or more food items, a humidity control chamber comprising an ambient air chamber separated from an extension chamber by a porous or perforated membrane, wherein the extension chamber is fluidly connected to the food item housing chamber and the ambient air chamber is fluidly connected with a surrounding environment of the mobile food transportation system, a fan positioned between the extension chamber and the food item housing chamber, and a vent positioned between the extension chamber and the food item housing chamber, wherein, during operation of the fan, moisture is at least partially removed from moisture-laden air passing through the extension chamber.

### CROSS REFERENCE TO RELATED APPLICATIONS

This application claims priority to U.S. Provisional Application No. 63/750,558, entitled “MOBILE FOOD TRANSPORTATION SYSTEM WITH HUMIDITY CONTROL”, filed Jan. 28, 2025, the entirety of which is incorporated by reference herein for all purposes.

### TECHNOLOGICAL FIELD

Example embodiments of the present disclosure relate generally to food transportation system and, more particularly, to mobile food transportation systems with humidity control.

### BACKGROUND

The food service industry relies upon quickly providing customers with freshly prepared food items. This goal is relatively straight-forward when a customer orders a food item at a food service establishment given the relatively short time between preparing the food item and consumption by the customer. To provide food items to customers at locations other than the establishment however (e.g., via catering services, delivery services to satellite locations, etc.), many food service establishments prepare certain food items and transport these items to customers at the other locations. By way of example, some food service companies maintain establishments that may not contain the necessary equipment to prepare the food on-site (e.g., food trucks, festival booths, pop-up stores, or the like) and/or provide catering services in which the food items must be previously-prepared.

As such, food delivery services are often looking for ways to ensure that these previously-prepared food items still taste fresh when ultimately served to customers at another location. Due to the substantial amount of transit time often incurred when transporting previously-prepared food items, food items are frequently delivered that are soggy or otherwise unappealing to the customer. As such, a need exists for providing a desirable food storage environment during the delivery process such that the customer receives a fresh item upon delivery.

Applicant has identified a number of deficiencies and problems associated with conventional systems and methods for safely providing and/or delivering previously-prepared food items to a customer at a location other than a brick-and-mortar food service establishment. Through applied effort, ingenuity, and innovation, many of these identified problems have been solved by developing solutions that are included in embodiments of the present disclosure, many examples of which are described in detail herein.

### BRIEF SUMMARY

Example embodiments of the present disclosure are directed to mobile food transportation systems with humidity control. In accordance with one exemplary embodiment of the present disclosure, a mobile food transportation system includes a food item housing chamber structured to support one or more food items, a humidity control chamber comprising an ambient air chamber separated from an extension chamber by a porous or perforated membrane, wherein the extension chamber is fluidly connected to the food item housing chamber and the ambient air chamber is fluidly connected with a surrounding environment of the mobile food transportation system, a first fan positioned between the extension chamber and the food item housing chamber, and a first vent positioned between the extension chamber and the food item housing chamber, wherein, during operation of the first fan, moisture is at least partially removed from moisture-laden air passing through the extension chamber.

In accordance with another exemplary embodiment of the present disclosure, a method of controlling humidity in a mobile food transportation system is provided, the method comprising receiving moisture-laden air from a food item housing chamber into an extension chamber of a humidity control chamber through a first opening between the food item housing chamber and the extension chamber; circulating the moisture-laden air through the extension chamber and along a porous or perforated membrane separating the extension chamber from an ambient air chamber; drawing ambient air from a surrounding environment through the ambient air chamber and across the porous or perforated membrane to create a low pressure zone that removes moisture from the moisture-laden air; and returning dehumidified air from the extension chamber to the food item housing chamber through a second opening between the extension chamber and the food item housing chamber.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1A illustrates a front top left perspective view of an example food transportation system according to various embodiments of the present disclosure.

FIG. 1B illustrates a back top perspective view of an example food transportation system according to various embodiments of the present disclosure.

FIG. 1C illustrates a back bottom left perspective view of an example food transportation system according to various embodiments of the present disclosure.

FIG. 1D illustrates another front top left perspective view of an example food transportation system, with the lid open, according to various embodiments of the present disclosure.

FIG. 1E illustrates a back top left perspective view of an example food transportation system, with the lid open, according to various embodiments of the present disclosure.

FIG. 1F illustrates another back top left perspective view of an example food transportation system, with the rear panel removed, according to various embodiments of the present disclosure.

FIG. 2A illustrates a ghosted/partially transparent front top left perspective view of an example food transportation system according to various embodiments of the present disclosure.

FIG. 2B illustrates a ghosted/partially transparent rear top left perspective view of an example food transportation system according to various embodiments of the present disclosure.

FIG. 2C illustrates another ghosted/partially transparent front top left perspective view of an example food transportation system according to various embodiments of the present disclosure.

FIG. 2D illustrates another ghosted/partially transparent rear top left perspective view of an example food transportation system according to various embodiments of the present disclosure.

FIG. 2E illustrates a ghosted/partially transparent front left perspective view of an example food transportation system according to various embodiments of the present disclosure.

FIG. 2F illustrates a ghosted/partially transparent front top right perspective view of an example food transportation system according to various embodiments of the present disclosure.

FIG. 2G illustrates a back view of an example food transportation system, with the rear panel removed, according to various embodiments of the present disclosure.

FIG. 2H illustrates a ghosted/partially transparent front top left perspective view of an example food transportation system according to various embodiments of the present disclosure.

FIG. 3 illustrates a schematic view of an example humidity control chamber according to various embodiments of the present disclosure.

FIG. 4 illustrates a schematic view of another example humidity control chamber according to various embodiments of the present disclosure.

FIG. 5A illustrates a perspective view of an example food container cradle according to various embodiments of the present disclosure.

FIG. 5B illustrates a bottom perspective view of an example food container cradle according to various embodiments of the present disclosure.

FIG. 5C illustrates a perspective view of an example food container cradle according to various embodiments of the present disclosure.

FIG. 5D illustrates a perspective view of an example food container cradle according to various embodiments of the present disclosure.

FIG. 5E illustrates a bottom view of an example food container cradle according to various embodiments of the present disclosure.

FIG. 5F illustrates a side view of an example food container cradle according to various embodiments of the present disclosure.

FIGS. 6A and 6B illustrate perspective views of an example food container according to various embodiments of the present disclosure.

FIG. 7 illustrates a schematic block diagram of example circuitry that may perform various operations of an example controller of a food transportation system structured in accordance with some example embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements.

As used herein, reference is made to controlling the humidity (e.g., a humidity control system) in a mobile food transportation system. The present disclosure, however, contemplates that the humidity control system of the present disclosure may be equally applicable to other devices where removing moisture and/or humidity is advantageous. Similarly, reference herein may be made to moisture-laden air in which at least a portion of the air within the described food transportation system includes a suspended fluid (e.g., water vapor, moisture, steam, or the like). Therefore, the amount of moisture within “moisture-laden air” and/or “air” as the terms are utilized herein may be dependent on the amount of water that evaporates from food within the food transportation system, the relative humidity of surrounding air, and/or the like. Thus, the terms “moisture-laden air” and “air” should not be read to limit the devices of the present disclosure to any particular quantity of suspended moisture or humidity. Like numbers refer to like elements throughout.

### Overview

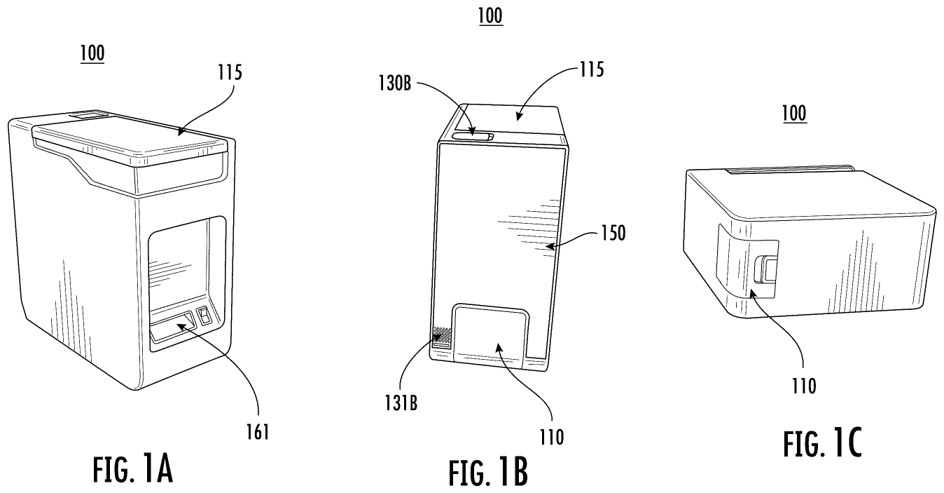

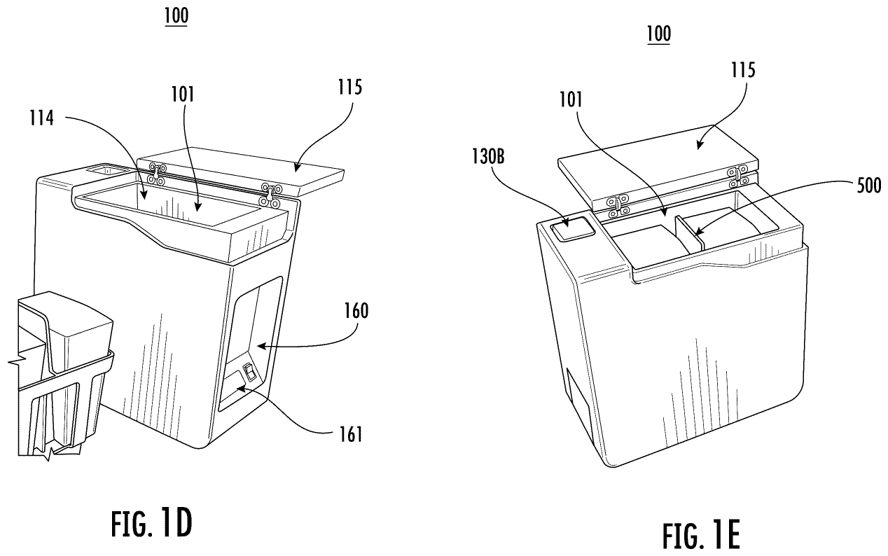

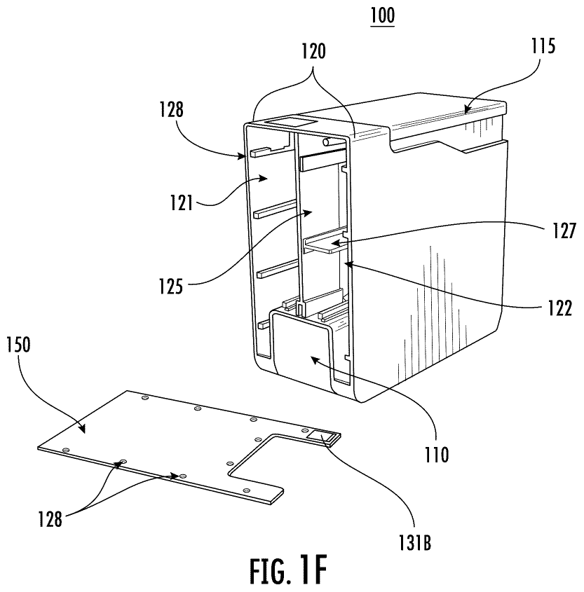

With reference to FIGS. 1A-1F, an example food transportation system 100 for use with food items in accordance with various embodiments of the present disclosure is illustrated. In various embodiments, the food transportation system 100 may comprise a shell or housing 105, the shell or housing 105 defining a food item housing chamber 101 (e.g., enclosure or the like) structured to support, enclose, or otherwise receive one or more food items 102. The shell or housing 105 defines one or more openings through which the one or more food items 102 may be inserted. For example, in the depicted embodiment, the shell or housing 105 defines a front wall, a back wall, a left wall, a right wall, a top surface and/or a bottom surface, a portion of the top surface defining an opening 114 which is associated with a lid 115 selectively providing access to the food item housing chamber 101. The opening 114 allows an operator (e.g., food delivery person, food service operator, or the like) to place cooked food items 102 within or to selectively access cooked food items 102 therein. The lid 115 minimizes the amount of air exchange between the interior of the food item housing chamber 101 and the surrounding environment when closed and/or otherwise sealing the opening 114. Although the opening 114 and associated lid 115 are depicted in the top surface of the housing 105, the present disclosure contemplates that an opening 114 (and associated lid 115) may be defined, additionally or alternatively, in one or more other wall(s) or surface(s) of the housing 105.

As depicted in FIGS. 1A-1F, the housing 105 may be made of a rigid material (e.g., plastic, metal, and/or the like) or combinations of materials. That is, the housing 105 may be formed of any material that provides sufficient rigidity to the embodiments of the present disclosure. Although not depicted, in other embodiments, the housing 105 may be an insulated bag comprising a flexible, thermally insulating material defining an enclosure (e.g., a food item housing chamber 101) for enclosing one or more food items 102 therein. In such an embodiment, the insulated bag may define an opening that may be selectively sealed via one or more fasteners (e.g., zippers, snaps, hook-and-loop fasteners, ties, and/or the like) to minimize the amount of air exchange between the interior of the food item housing chamber 101 and the surrounding environment when sealed. As just one example, the insulated bag may be defined by a structure formed of a high-density thermal insulation for enclosing various food items 102 during transit.

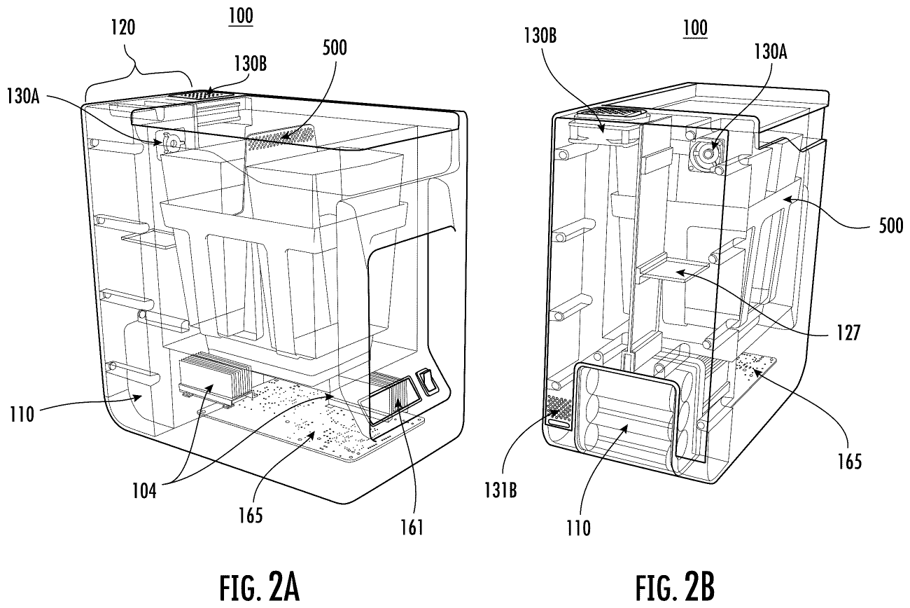

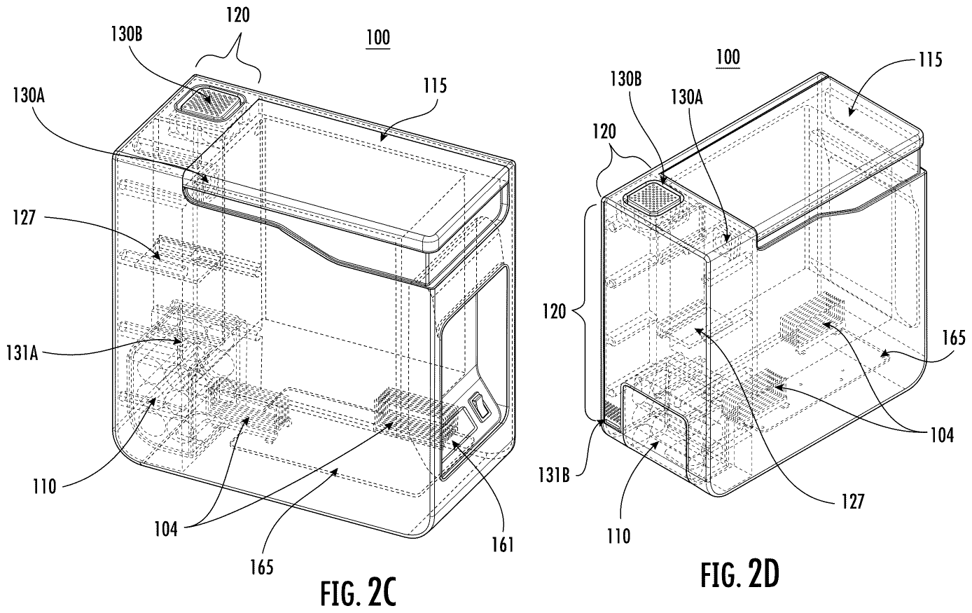

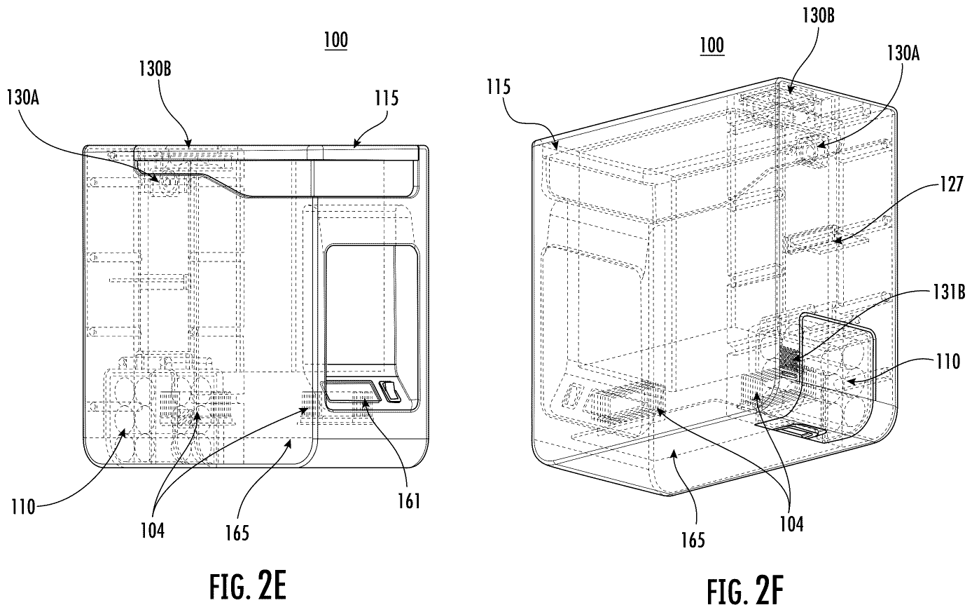

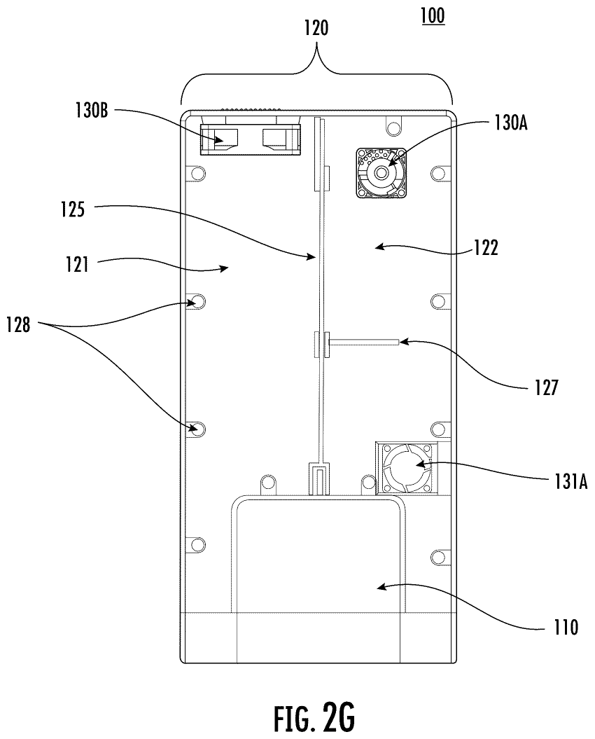

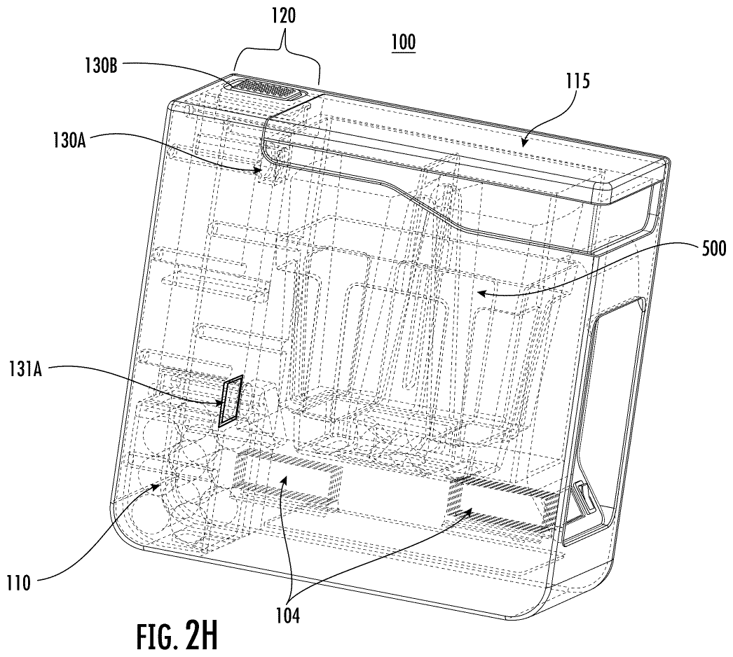

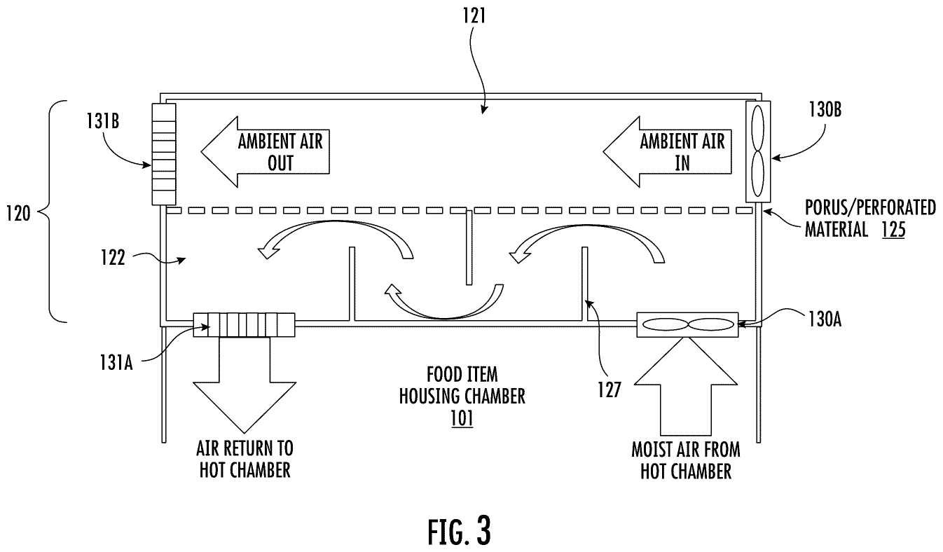

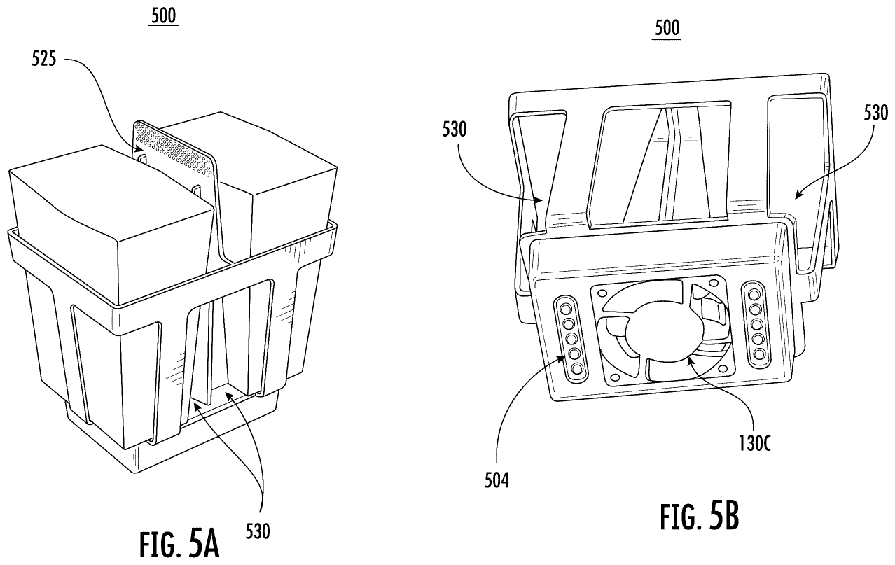

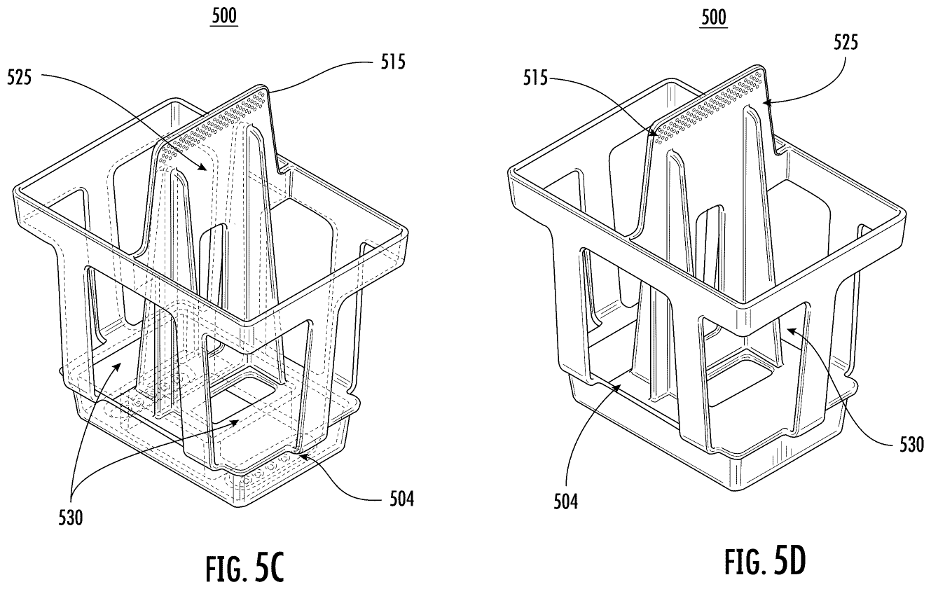

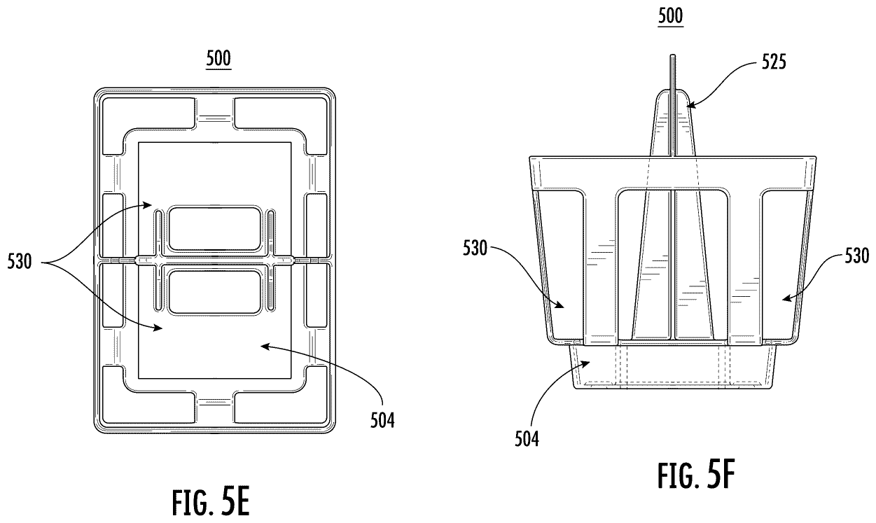

In some instances, a food transportation system 100 may include various racks, shelves, containers, caddies, carriers, etc. for supporting the one or more food items 102 therein. For example, with reference to FIGS. 1E and 2A, a food container cradle 500 may be structured to load and/or unload the food items 102 from the food item housing chamber 101 and/or otherwise support the food items 102 within the food item housing chamber 101. As described in more detail with respect to FIGS. 5A-5F, the food container cradle 500 may be structured to electrically communicate with the food transportation system 100 and/or comprise a fan (e.g., third fan 130C).

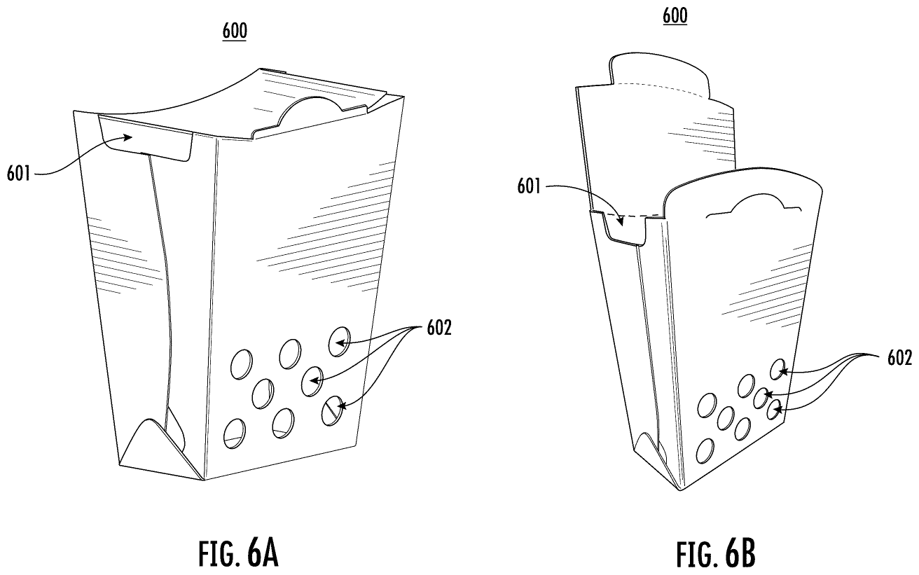

As would be evident to one of ordinary skill in the art in light of the present disclosure, the various food items 102 may also be independently enclosed (e.g., within pouches, bags, containers, or the like) within the food transportation system 100. By way of example, one or more food items 102 may be housed within food bags or food containers so as to separate orders during delivery of the food items. As described in more detail with respect to FIGS. 6A and 6B, a food container 600 may be structured to provide and/or improve air flow through the interior of the food container 600.

In some embodiments, the food transportation system 100 may include a control portion 160 (e.g., housing a user interface 161 including a display and interactive user elements (e.g., buttons). For example, the display may indicate relative humidity levels measured within the food transportation system 100, whether the system is powered on or off, whether there are any errors in the system, a low battery indication, or the like.

As depicted in the ghosted/partially transparent views of FIGS. 2A, 2C-2F, and 2H, inferring the internal components of the food transportation system 100, in some embodiments, a food transportation system 100 may include one or more heating elements 104 configured to maintain the temperature of, warm, and/or impart heat (e.g., via conduction, convection, radiation, etc.) to the various food items 102 within the food transportation system 100. In some embodiments, the heating element(s) 104 may comprise a low voltage heater configured to transfer heat to the air so as to warm the air passing therethrough. The heater may be adjustable in terms of its heat output and controllable by the controller, as discussed below. In some embodiments, the one or more heating elements 104 may comprise a high heat capacity material so as to remain relatively hot during the transportation of the food items 102. In such an embodiment, the one or more heating elements 104 may be heated to a sufficient temperature prior to insertion within the food transportation system 100. By way of example, a heating element 104 may be placed in an oven (or other equivalent ambient heat source) and/or may include an integrated heater (e.g., that may be plugged into an external power source) configured to heat the heating element 104 to the requisite temperature. In some embodiments, the food transportation system 100 may include an integrated heater and associated fan system configured to circulate relatively warm air within the food transportation system 100 so as to warm (or otherwise maintain the heat of) the food items 102 therein.

In some embodiments, the food transportation system 100, or one or more portion(s) thereof, is powered (and/or back-up powered) by one or more of an electrical system, a battery 110, or the like. In an exemplary embodiment, the food transportation system 100 is electrically connected to the electrical system of a motor vehicle in which the food transportation system 100 is disposed. In some embodiments, the food transportation system 100, or one or more portion(s) thereof, is powered by one or more batteries electrically connected to the system 100. For example, the food transportation system 100 may comprise one or more batteries 110. As depicted in FIGS. 1B, 1C, and 1F, the housing 105 may define a battery chamber 109 configured to receive one or more batteries 110 (e.g., rechargeable battery pack 110). For example, in some embodiments, the battery chamber may be accessible from an exterior of the food transportation system 100 such that a rechargeable battery pack 110 may be easily swapped out by a food delivery person. By enabling the food transportation system 100 to remain in the motor vehicle and swapping of the battery 110 (or being electrically connected to the electrical system of a motor vehicle) reduces the weight load requirements for a food delivery person. For example, instead of transporting the entire food transportation system 100 into and out of a restaurant for recharging, the food transportation system 100 may in some instances remain in the motor vehicle.

As would be evident to one of ordinary skill in the art in light of the present disclosure, the humidity level (e.g., ratio of moisture within the air) within the food transportation system 100 may increase over time such that the food items 102 within the food transportation system 100 soften (e.g., become soggy) due to the moisture that may evaporate from the contained food items 102 enclosed within the food item housing chamber 101 (e.g., the moisture cannot effectively escape the closed food transportation system 100). Said differently, the food items 102 may be inserted into the food item housing chamber 101 shortly after being prepared (e.g., following removal of the food items from an oven, a deep fryer, or the like) such that the food items 102 are at a desirable temperature for customer consumption. As the temperature of the food items 102 decreases over time (e.g., within the enclosed food item housing chamber 101 of the food transportation system 100), the moisture within or on the food items 102 may condense and increase the relative humidity within the food transportation system 100.

As such, various embodiments of the present disclosure provide for humidity control in order to reduce the relative humidity within the food transportation system 100. For example, in various embodiments, the shell or housing 105 of the food transportation system 100 may define a humidity control chamber 120 in fluid communication with the food item housing chamber 101. For example, as depicted in the non-limiting embodiments of FIGS. 1F, 2A, 2C, 2D, 2G, and 2H, the humidity control chamber 120 is defined in the rear portion of the food transportation system 100, positioned between the food item housing chamber 101 and the back wall of the food transportation system 100, and may be accessible by removing a rear panel 150 that may be cover and/or seal an opening in the food transportation system 100 via one or more fasteners 128 (e.g., magnets, screws, and/or the like). While described in reference to the rear of the food transportation system 100, the present disclosure contemplates that the humidity control chamber 120 may be located anywhere within the food transportation system 100 as long as the humidity control chamber 120 is in fluid communication with the food item housing chamber 101 and provides sufficient humidity control within the food transportation system 100.

As depicted in the food transportation system 100 of FIGS. 1F and 2G, with the rear panel 150 removed, and in the ghosted/partially transparent view of FIG. 2B inferring the internal components of the food transportation system 100, in some embodiments, the humidity control chamber 120 comprises a porous or perforated material 125 (e.g., a porous or perforated membrane) subdividing the humidity control chamber 120 into an ambient air chamber 121 and an extension chamber 122. Although the porous or perforated material 125, ambient air chamber 121, and extension chamber 122 are depicted in a vertical orientation in FIGS. 1F, 2B, and 2G (e.g., the porous or perforated material 125 is a vertical member dividing the ambient air chamber 121 on the left from the extension chamber 122 on the right-a porous or perforated membrane), the present disclosure contemplates that the porous or perforated material 125, ambient air chamber 121, and extension chamber 122 may be disposed in any orientation as long as the humidity control chamber 120 is in fluid communication with the food item housing chamber 101 and provides sufficient humidity control within the food transportation system 100.

Regardless of the configuration or orientation of the components, the porous or perforated material 125 is configured to wick moisture from the moisture-laden air in the food transportation system 100. In some embodiments, the porous or perforated material 125 may be a porous material such as Porex® sintered frits or a perforated material, such as a polypropylene or similar material, perforated (e.g., injection molded or the like) with a plurality of holes. As used herein, the term “wick” is intended to mean any process by which water is at least partially removed from humid air and deposited on and/or transmitted through the porous or perforated materials, such as through capillary action, diffusion, osmosis, or the like. For example, in some embodiments, the humidity control chamber 120 comprises a polypropylene sheet perforated with a plurality of holes subdividing the ambient air chamber 121 from the extension chamber 122. Such a perforated polypropylene sheet may provide for ease of cleaning and provide food safety benefits. In some embodiments, the number and size of the holes may be controlled to create and/or enable sufficient pressure flow. For example, in some embodiments, one or more holes may be larger than 0.1 inches in diameter. In still other embodiments, one or more holes may be larger than 0.15 inches in diameter. In still further embodiments, one or more holes may be 0.155 inches in a diameter. The porous or perforated material 125 (e.g., a porous or perforated membrane) provides constant humidity control without adding too much weight to the food transportation system 100, and with less maintenance as compared to previous systems. In some embodiments, the porous or perforated material 125 provides constant temperature control without temperature variation.

One or more fans 130 and one or more vents 131 may be disposed in the ambient air chamber 121 and/or the extension chamber 122 in order to circulate air (moisture-laden or otherwise) into and out of the humidity control chamber 120. For example, in some embodiments, as illustrated in FIGS. 2A-2H, a first fan 130A may be positioned, near the top, in the wall dividing the food item housing chamber 101 from the extension chamber 122 portion of the humidity control chamber 120. As depicted in FIGS. 2C, 2G, and 2H, a first vent 131A may also be positioned, near the bottom, in the wall dividing the food item housing chamber 101 from the extension chamber 122 portion of the humidity control chamber 120. In some embodiments, the first fan 130A may be configured (e.g., direction of fan blade rotation or the like) to operate as an air inlet configured to accept moisture-laden air from the interior of the food item housing chamber 101 and the first vent 131A may be configured such to operate as an air outlet allowing air to reenter the food item housing chamber 101 from the humidity control chamber 120 (the extension chamber 122). The extension chamber 122 may comprise one or more air baffles 127 which obstruct the flow of moisture laden air flowing through the extension chamber 122 from the inlet to the outlet, effectively slowing down the air flow and providing sufficient exposure to the porous or perforated material 125 (e.g., a porous or perforated membrane) and air flow occurring in the ambient air chamber 121 as described below.

Similarly, in some embodiments, as illustrated in FIGS. 2A-2H, a second fan 130B may be positioned in the top surface of the housing 105 on the ambient air chamber 121 portion of the humidity control chamber 120 and a second vent 131B may also be positioned, near the bottom, in the back wall (e.g., rear panel 150) of the housing 105 on the ambient air chamber 121 portion of the humidity control chamber 120. In some embodiments, the second fan 130B may be configured (e.g., direction of fan blade rotation or the like) to operate as an air inlet configured to accept ambient air from the surrounding environment of the food transportation system 100 and the first vent 131B (e.g., plurality of vent holes disposed in rear panel 150 as depicted in FIGS. 1F, 2B, and 2D) may be configured to operate as an air outlet allowing air to exit the food transportation system 100 from the humidity control chamber 120 (the ambient air chamber 121). The second fan 130B and second vent 131B are configured to move ambient air from the surrounding environment across the porous or perforated material 125, creating a low pressure gap, which pulls moisture from the moisture-laden air flowing through the extension chamber 122.

The present disclosure contemplates that the fans 130A, 130B and vents 131A, 131B may be disposed in any number, location, or configuration as long as the relevant orientation provides sufficient humidity control within the food transportation system 100. In some embodiments, one or more fans are additionally or alternatively disposed within the food item housing chamber 101. For example, a third fan 130C may be centrally located in the bottom of the food item housing chamber 101 of the food transportation system 100 (e.g., vertically below the food items 102) in order to push air received from the extension chamber 122 of the humidity control chamber 120 up through the food items 102. In some embodiments, the third fan 130C is positioned within the food item housing chamber 101 (e.g., a bottom surface of the food item housing chamber 101). In other embodiments, the third fan 130C may be positioned within the bottom portion of a food container cradle 500 placed within the food item housing chamber 101 as described in more detail with respect to FIGS. 6A and 6B. All of the fans may be variable speed fans and their speed controlled by a controller, as further discussed below.

With reference to FIG. 3, a schematic illustration of the humidity control chamber 120 in accordance with various embodiments of the present disclosure is illustrated. In FIG. 3, moisture-laden air is pulled from the food item housing chamber 101 through a fan 130A rotating such that the fan 130A operates as an inlet to the extension chamber 122. The moisture-laden air circulates through the extension chamber 122, flowing around the plurality of air baffles 127 and coming into contact with the porous or perforated material 125 (e.g., a porous or perforated membrane), and exiting through the vent 131A operating as an outlet and back into the food item housing chamber 101. At the same time, ambient air, which is typically cooler than the moisture-laden air being heated by heating element(s) 104 and circulating in the food item housing chamber 101 and extension chamber 122, is pulled in from the surrounding environment of the food transportation system via a fan 130B operating as an inlet in the ambient air chamber 121, flowing across the opposite side of the porous or perforated material 125, creating a low pressure (e.g., vacuum) zone in the ambient air chamber 121 as the ambient air exits the ambient air chamber via the vent 131B operating as an outlet. The porous or perforated material 125 wicks away moisture from the moisture-laden air, with a portion of the moisture combining and exiting with the ambient air from the ambient air chamber 121 and any excess portion of moisture (e.g., condensation) collecting at the bottom of the extension chamber 122, which may be removed periodically and/or collected in a condensation collector configured to receive excess fluid condensed from the moisture-laden air but not wicked to the other side of the porous or perforated material 125. A condensation collection may, for example, span the entirety of the bottom of the extension chamber 122 or only a portion thereof. The condensation collector may be removably attached to the housing 105 such that the fluid condensed from the moisture-laden air may be emptied from the food transportation system by a user or otherwise.

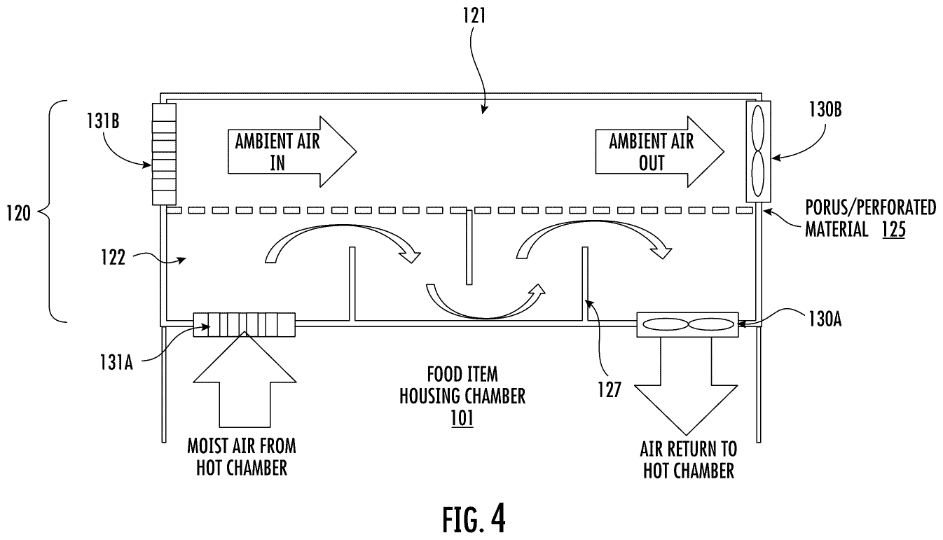

With reference to FIG. 4, a schematic illustration of another humidity control chamber 120 in accordance with various embodiments of the present disclosure is illustrated. In FIG. 4, moisture-laden air is pulled from the food item housing chamber 101 through a vent 131A operating as an inlet in the extension chamber 122. The vent 131A operates as an inlet in comparison to the outlet vent in FIG. 3 due to the rotation and fan blade orientation of the fan 130A. In FIG. 4, the fan 130A operates as an outlet to the extension chamber 122. The moisture-laden air circulates through the extension chamber 122, flowing around the plurality of air baffles 127 and coming into contact with the porous or perforated material 125, and exiting through the fan 130A operating as an outlet and back into the food item housing chamber 101. At the same time, ambient air, which is typically cooler than the moisture-laden air being heated by heating element(s) 104 and circulating in the food item housing chamber 101 and extension chamber 122, is pulled in from the surrounding environment of the food transportation system through a vent 131B operating as an inlet to ambient air chamber 121, flowing across the opposite side of the porous or perforated material 125, creating a low pressure (e.g., vacuum) zone in the ambient air chamber 121 as the ambient air exits the ambient air chamber 121 via the fan 130B operating as an outlet. The porous or perforated material 125 (e.g., a porous or perforated membrane) wicks away moisture from the moisture-laden air, with a portion of the moisture combining and exiting with the ambient air from the ambient air chamber 121 and any excess portion of moisture collecting at the bottom of the extension chamber 122, which may be removed periodically and/or collected in a condensation collector configured to receive excess fluid condensed from the moisture-laden air but not wicked to the other side of the porous or perforated material 125. A condensation collection may, for example, span the entirety of the bottom of the extension chamber 122 or only a portion thereof. The condensation collector may be removably attached to the housing 105 such that the fluid condensed from the moisture-laden air may be emptied from the food transportation system by a user or otherwise.

According to at least one example embodiment described hereafter, the food transportation system 100 may, in some embodiments, include a humidity sensor and the humidity sensor may be configured to determine a relative humidity of the interior of the food item housing chamber 101. The relative humidity sensor may, in an instance in which the relative humidity within the food item housing chamber 101 satisfies a defined criteria (e.g., meets or exceeds a defined threshold), cause the moisture-laden air to enter the extension chamber 122 of the humidity control chamber 120 and/or cause ambient air to flow through the ambient air chamber 121 of the humidity control chamber (e.g., via one or more of the fans 130A, 130B, 130C, positive pressure, or the like). In an instance in which the relative humidity within the food item housing chamber 101 satisfies the defined criteria, the food transportation system 100 may force the moisture-laden air into the extension chamber 122 of the humidity control chamber 120 (e.g., via the vent 131A or fan 130A operating as an inlet) while also forcing ambient air into the ambient air chamber 121 (e.g., via the vent 131B or fan 130B).

As would be evident to one of ordinary skill in the art in light of the present disclosure, the temperature of the food items 102 within the food transportation system 100 may decrease over time such that the food items 102 within the food transportation system 100 may cool (e.g., to an undesirable temperature for customer consumption) during transportation. As described above, the food items 102 may be inserted into the food transportation system 100 shortly after being prepared (e.g., following removal of the food items 102 from an oven, a deep fryer, or the like) such that the food items 102 are at a desirable temperature for customer consumption. During transportation, however, heat from the food items 102 may dissipate from the food items 102 to the environment (e.g., the interior of the food transportation system 100 or otherwise). Furthermore, the food transportation system 100 may be opened and closed (e.g., so as to remove food items for delivery) such that heat within the food transportation system 100 is dissipated to an external environment of the food transportation system 100.

As such, according to at least one example embodiment described hereafter, the food transportation system 100 may include a temperature sensor configured to determine a temperature of the interior of the food item housing chamber 101 (e.g., and by association the temperature of the food items 102 therein). The temperature sensor may, in an instance in which the temperature within the food item housing chamber 101 fails to satisfy a defined criteria (e.g., fails to meet or exceed a defined threshold, such as 185° F.), cause the air within the food transportation system 100 to flow over and/or in contact with the one or more heating elements 104 (e.g., via a fan, positive pressure, or the like). The heating element(s) 104 may be configured to warm (e.g., impart heat) to the air directed therethrough such that warmer air may be directed up through the food items 102 in the food item housing chamber 101. The temperature sensor may, in some embodiments, operate in conjunction with the humidity sensor described above to cause the air within the food item housing chamber 101 (moisture-laden or otherwise) to enter into the humidity control chamber 120. In other embodiments, the temperature sensor and associated temperature control elements may be located separate from the humidity control elements.

During operation, the relative humidity within the interior of the food item housing chamber 101 may increase (e.g., due to opening the lid 115, via moisture within food items 102 inserted therein evaporating, etc.) to a value of 65%. A controller (e.g., printed circuit board 165) may be in communicably connected to the humidity sensor and configured to continuously monitor the data received from the humidity sensor. For example, the controller may be configured to compare this 65% relative humidity value to the defined 50% relative humidity threshold value, and may determine that the data exceeds the defined relative humidity threshold. In an instance in which the relative humidity exceeds the defined relative humidity threshold, the food transportation system 100 may force the moisture-laden air within the food item housing chamber 101 into the humidity control chamber 120 as described herein. For example, the controller sends one or more signals to turn on or adjust the speed of one or more of the fans (e.g., 130A, 130B, 130C). While described in reference to a defined relative humidity threshold, the present disclosure contemplates that, in some embodiments, the threshold relative humidity value may be varied by the controller or by user interaction based upon the contents within the food transportation system 100. According to embodiments, the controller may be a PID controller configured to adjust the fan speeds and heater temperatures to account for rate-of-change deviations in the temperature and/or humidity.

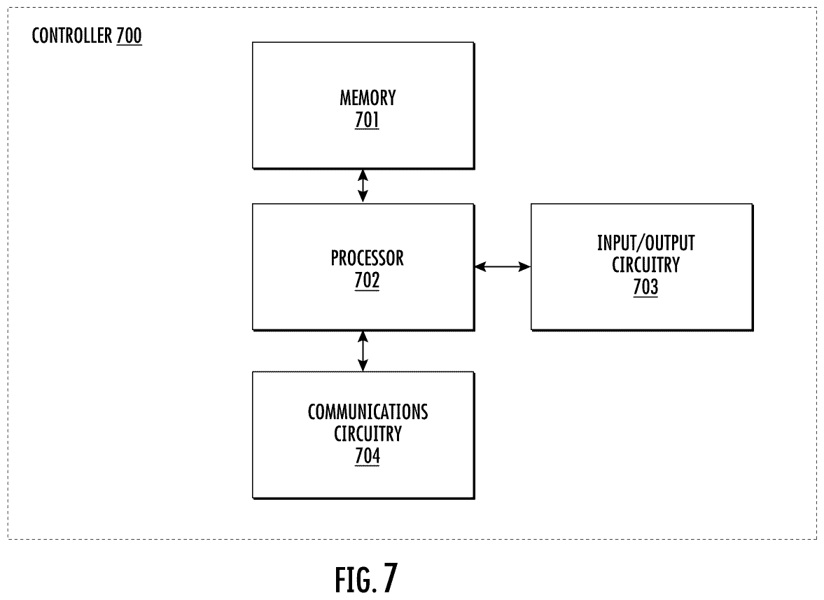

With reference to FIG. 7, the food transportation system 100 may include circuitry, networked processors, or the like configured to perform some or all of the processes described herein. For example, in some embodiments, the food transportation system 100 may include controller 700 (e.g., printed circuit board 165) configured to receive data from the one or more sensors (e.g., in electrical communication with the humidity sensor and/or the temperature sensor). FIG. 7 illustrates a schematic block diagram of example circuitry, some or all of which may be included in an example controller 700 that may be embodied by, at least partially embodied by, or may be commutatively connected to, the food transportation system 100 or any components thereof. However, it should be noted that the components, devices, and elements illustrated in and described with respect to FIG. 7 below may not be mandatory and thus some may be omitted in certain embodiments. Additionally, some embodiments may include further or different components, devices, or elements beyond those illustrated in and described with respect to FIG. 7.

In some embodiments, the controller 700 may be implemented as, or at least partially as, a distributed system or cloud-based system and may therefore include any number of remote server devices. Accordingly, example embodiments of the controller 700 may employ remote processing and/or monitoring of data collected by the sensor(s) such that processing of such data may be performed on servers and/or other like computing devices. Regardless of implementation, controller 700 may be configured to control various components of the food transportation system 100 (e.g., humidity sensor, temperature sensor, fan(s), battery, etc.) as described herein.

Continuing with FIG. 7, controller 700 may be configured to perform actions in accordance with one or more example embodiments disclosed herein. In this regard, the controller 700 may be configured to perform and/or control performance of one or more functionalities of the food transportation system 100 and/or components thereof in accordance with various example embodiments. For example, the controller 700 may be in communication with or otherwise control the sensor(s) (e.g., control the humidity sensor) and/or other components of the food transportation system 100 (e.g., fans, user interface, etc.). The controller 700 may be further configured to perform data processing, such as processing of data collected by the humidity sensor. In some embodiments, controller 700, or a component(s) thereof, may be embodied as or comprise a circuit chip (e.g., an integrated circuit chip) configured (e.g., with hardware, software, or a combination of hardware and software) to perform operations described herein. The circuit chip may constitute various means, such as memory 701, processor 702, input/output circuitry 703, and/or communications circuitry 704, for performing one or more operations for providing the functionalities described herein. For example, a controller 700 may be configured, using one or more of the circuitry 701, 702, 703, and 704, to execute the operations of sensor data acquisition, powering on and/or off of the fan(s) 130A, 130B, 130C and/or heating element(s) 104, monitoring GPS location, remotely communicating with, for example, a food establishment, etc.

Although the use of the term “circuitry” as used herein with respect to components 701-704 are described in some cases using functional language, it should be understood that the particular implementations necessarily include the use of particular hardware configured to perform the functions associated with the respective circuitry as described herein. It should also be understood that certain of these components 701-704 may include similar or common hardware. For example, two sets of circuitry may both leverage use of the same processor, network interface, storage medium, or the like to perform their associated functions, such that duplicate hardware is not required for each set of circuitry. It will be understood in this regard that some of the components described in connection with the controller 700 may be housed within the food transportation system 100, while other components are housed within another of these systems, or by yet another device not expressly illustrated.

While the term “circuitry” should be understood broadly to include hardware, in some embodiments, the term “circuitry” also includes software for configuring the hardware. For example, in some embodiments, “circuitry” may include processing circuitry, storage media, network interfaces, input/output devices, and the like. In some embodiments, other elements of the controller 700 may provide or supplement the functionality of particular circuitry. For example, the processor 702 may provide processing functionality, the memory 701 may provide storage functionality, the communications circuitry 704 may provide network interface functionality, and the like.

In some embodiments, the processor 702 (and/or co-processor or any other processing circuitry assisting or otherwise associated with the processor) may be in communication with the memory 701 via a bus for passing information among components of, for example, controller 700. The memory 701 is non-transitory and may include, for example, one or more volatile and/or non-volatile memories, or some combination thereof. In other words, for example, the memory 701 may be an electronic storage device (e.g., a non-transitory computer readable storage medium). The memory 701 may be configured to store information, data, content, signals, applications, instructions (e.g., computer-executable program code instructions), or the like, for enabling a controller 700 to carry out various functions in accordance with example embodiments of the present disclosure. For example, memory 701 may be configured to store sensor data software, thresholds, and/or any other suitable data or data structures. It will be understood that the memory 701 may be configured to store partially or wholly any electronic information, data, data structures, embodiments, examples, figures, processes, operations, techniques, algorithms, instructions, systems, apparatuses, methods, or computer program products described herein, or any combination thereof.

Although illustrated in FIG. 7 as a single memory, memory 701 may comprise a plurality of memory components. The plurality of memory components may be embodied on a single computing device or distributed across a plurality of computing devices. In various embodiments, memory 701 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 701 may be configured to store information, data, applications, instructions, or the like for enabling controller 700 to carry out various functions in accordance with example embodiments discussed herein. For example, in at least some embodiments, memory 701 is configured to buffer data for processing by processor 702. Additionally or alternatively, in at least some embodiments, memory 701 is configured to store program instructions for execution by processor 702. Memory 701 may store information in the form of static and/or dynamic information. This stored information may be stored and/or used by controller 700 during the course of performing its functionalities.

Processor 702 may be embodied in a number of different ways and may, for example, include one or more processing devices configured to perform independently. Additionally, or alternatively, processor 702 may include one or more processors configured in tandem via a bus to enable independent execution of instructions, pipelining, and/or multithreading. Processor 702 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the controller 700, and/or remote or “cloud” processors. Accordingly, although illustrated in FIG. 7 as a single processor, it will be appreciated that in some embodiments, processor 702 comprises a plurality of processors. The plurality of processors may be embodied on a single computing device or may be distributed across a plurality of such devices collectively configured to function as controller 700. The plurality of processors may be in operative communication with each other and may be collectively configured to perform one or more functionalities of controller 700 as described herein. For example, some operations performed herein may be performed by components of the controller 700 while some operations may be performed on a remote device communicatively connected to the controller 700. For example, a user device such as a smart phone, tablet, personal computer and/or the like may be configured to communicate with the controller 700 such as by Bluetooth™ communication or over a local area network. Additionally or alternatively, a remote server device may perform some of the operations described herein, such as processing data collected by any of the sensors, and providing or communicating resultant data to other devices accordingly.

In an example embodiment, processor 702 is configured to execute instructions stored in the memory 701 or otherwise accessible to processor 702. Alternatively, or additionally, the processor 702 may be configured to execute hard-coded functionality. As such, whether configured by hardware or software methods, or by a combination thereof, the processor 702 may represent an entity (e.g., physically embodied in circuitry) capable of performing operations according to an embodiment of the present disclosure while configured accordingly. Thus, for example, when the processor 702 is embodied as an ASIC, FPGA, or the like, the processor 702 may be specifically configured hardware for conducting the operations described herein. Alternatively, as another example, when the processor 702 is embodied as an executor of software instructions, the instructions may specifically configure processor 702 to perform one or more algorithms and/or operations described herein when the instructions are executed. For example, these instructions, when executed by processor 702, may cause controller 700 to perform one or more of the functionalities of controller 700 as described herein.

In some embodiments, controller 700 further includes input/output circuitry 703 that may, in turn, be in communication with processor 702 to provide an audible, visual, mechanical, or other output and/or, in some embodiments, to receive an indication of an input from a user or another source. In that sense, input/output circuitry 703 may include means for performing analog-to-digital and/or digital-to-analog data conversions. Input/output circuitry 703 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 703 may comprise a user interface and may comprise a web user interface, a mobile application, or the like. The processor 702 and/or user interface circuitry comprising the processor 702 may be configured to control one or more functions of a display or one or more user interface elements through computer program instructions (e.g., software and/or firmware) stored on a memory accessible to the processor 702 (e.g., memory 701, and/or the like). In some embodiments, aspects of input/output circuitry 703 may be reduced or may even be eliminated from controller 700. Input/output circuitry 703 may be in communication with memory 701, communications circuitry 704, and/or any other component(s), such as via a bus. Although more than one input/output circuitry 703 and/or other component can be included in controller 700, only one is shown in FIG. 7 to avoid overcomplicating the disclosure (e.g., like the other components discussed herein).

Communications circuitry 704, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with controller 700. In this regard, communications circuitry 704 may include, for example, a network interface for enabling communications with a wired or wireless communication network. Accordingly, the communications circuitry 704 may, for example, include supporting hardware and/or software for enabling wireless and/or wireline communications via cable, digital subscriber line (DSL), universal serial bus (USB), Ethernet, or other methods.

In some embodiments, the communications circuitry 704 may include a network configured to transmit information amongst various devices. By way of example, the communications circuitry 704 may be configured to enable communication amongst components of the food transportation system 100, the sensor(s), and/or remote computing devices. In some embodiments, communications circuitry 704 is configured to receive and/or transmit any data that may be stored by memory 701 using any protocol that may be used for communications between computing devices. For example, communications circuitry 704 may include one or more network interface cards, antennae, transmitters, receivers, buses, switches, routers, modems, and supporting hardware and/or software, and/or firmware/software, or any other device suitable for enabling communications via a network. Additionally or alternatively, in some embodiments, communications circuitry 704 includes circuitry for interacting with the antenna(s) to cause transmission of signals via the antenna(e) or to handle receipt of signals received via the antenna(e). These signals may be transmitted by controller 700 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The network in which controller 700 and/or any of the components thereof may operate may include a local area network, the Internet, any other form of a network, or in any combination thereof, including proprietary private and semi-private networks and public networks. The network may comprise a wired network and/or a wireless network (e.g., a cellular network, wireless local area network, wireless wide area network, some combination thereof, and/or the like). Communications circuitry 704 may additionally or alternatively be in communication with the memory 701, input/output circuitry 703 and/or any other component of controller 700, such as via a bus.

### Food Container Cradle

With reference to FIGS. 5A-5F, a food container cradle in accordance with various embodiments of the present disclosure is illustrated. A food container cradle 500 may be structured to load and/or unload the food items 102 from the food item housing chamber 101 and/or otherwise support the food items 102 within the food item housing chamber 101. For example, for ease of use, a food transportation system 100 may be located within the mobile delivery vehicle and instead of transporting the entire food transportation system 100 between the mobile delivery vehicle and the food establishment and/or the remote customer, a food container cradle 500 may be configured to be loaded with food items 102 (e.g., in food containers) in the food establishment, carried to the mobile delivery vehicle, and then removably placed in the food item housing chamber 101 of the food transportation system 100. In another example, the food delivery person may in turn remove the food container cradle 500 including the food items 102 from the food transportation system 100 when delivering to the remote customer.

As depicted in FIGS. 5A-5F, in some embodiments, the food container cradle 500 includes two seats or positions 530, each seat or position 530 structured to hold a food container (e.g., a food container 600). Although depicted with two seats or positions 530, the present disclosure contemplates that the food container cradle 500 contain any number of seats or positions 530 that provides sufficient capacity to the embodiments of the present disclosure. In considering the number of seats or positions 530, the weight capacity of the food container cradle 500 at full capacity may also be a consideration.

In some embodiments, the food container cradle 500 includes a handle portion 525 configured for handling or otherwise grasping the food container cradle 500 to remove, insert, or otherwise carry the food container cradle 500. In certain embodiments, the handle portion 525 comprises one or more perforations 515 to further assist in air flow around food items 102 when placed in the food item housing chamber 101 with the lid 115 closed.

In some embodiments, the food container cradle 500 includes a fan (e.g., fan 130C) positioned at the bottom of the food container cradle 500. When docked in the food item housing chamber 101 of the food transportation system 100, the fan 130C operates to pull heated air from below the food item housing chamber 101 (e.g., air heated by heating elements 104) up through and around the food items 102 seated in the food container cradle 500. In such embodiments, the fan 130C may operate in conjunction with fan 130A disposed between the food item housing chamber 101 and the extension chamber 122 to circulate air (e.g., air being pushed through food items by fan 130C carries moisture away from food items and to inlet of food item housing chamber 101, where captured moisture may be effectively removed.

In some embodiments, the food container cradle 500 includes an additional heating element (e.g., heating element 504) positioned at the bottom of the food container cradle 500, such heating element 504 assisting in keeping the food items 102 in the cradle warm when the food container cradle 500 is removed from or not otherwise docked in the food item housing chamber 101 (e.g., for transporting food items 102 from the food establishment to food transportation system 100 in a mobile delivery vehicle and/or from the food transportation system 100 to a remote customer at delivery). For example, the heating element 504 may be configured to maintain the temperature of, warm, and/or impart heat (e.g., via conduction, convection, radiation, etc.) to the various food items 102 within the food container cradle 500.

In some embodiments, the food container cradle 500 further comprises a rechargeable battery (not pictured) that operates to supply power to the fan 130C and/or heating element 504 in the food container cradle 500 when the food container cradle 500 is removed from or not otherwise docked in the food item housing chamber 101 (e.g., for transporting food items 102 from the food establishment to food transportation system 100 in a mobile delivery vehicle and/or from the food transportation system 100 to a remote customer at delivery), such that the fan 130C may continue to push air through and around any food items 102 seated in the food container cradle 500 and/or the heating element 504 may impart heat to the various food items 102 within the food container cradle 500. The food container cradle 500 may be structured to electrically communicate with the food transportation system 100 so that once the food container cradle 500 is docked back in the food item housing chamber, the battery 110 of the food transportation system 100 recharges the battery of the food container cradle 500. The communication can be by way of one or more pogo connectors that automatically connect when the food container cradle 500 is placed in the food item housing chamber 101. Further, the connectors may transmit data signals to control the fan 130C and heating element 104, 504 when connected, and also to provide feedback to the controller about battery charge status or error codes.

### Food Container

With reference to FIGS. 6A and 6B, a food container in accordance with various embodiments of the present disclosure is illustrated. As described above, the various food items 102 may be independently enclosed (e.g., within pouches, bags, containers, or the like) within the food transportation system 100 so as to separate orders during delivery of the food items 102. The food container 600 may be configured to house one or more food items 102, such as fries. In some embodiments, the food container 600 is structured to facilitate the transfer of heat and/or humidity (e.g., moisture) between the individual food items 102 and the air within the system 100. For example, the food container 600 comprises one or more perforations 602 at the bottom of the food container 600, allowing warm air to enter from the bottom of the food container 600, and flow up and around the food item 102, for example, individual fries, and out at or near the top of the food container 600, which defines one or more outlets 601 when the lid of the food container 600 is closed, creating a chimney effect through the food container 600. For example, the food transportation system 100 may include one or more heating elements 104 configured to warm (or otherwise impart heat to) the air within the housing 105. The food transportation system 100 may circulate air (moisture-laden or otherwise) within the food item housing chamber 101 via one or more fans (e.g., 130A, 130C), vents (e.g., 131A), etc. such that the air substantially passes thereby or sufficiently contacts the heating elements 104 and is warmed (e.g., via conduction, convection, radiation, etc.). For example, fan 130C may be centrally located in the bottom of the food item housing chamber 101 or the food container cradle 500 (e.g., vertically below the food items 102).

### Overview of Terms

For the purposes of the present application, the following explanations of terms are provided to better describe the present disclosure and to guide those of ordinary skill in the art in the practice of the present disclosure:

As used herein, the term “comprising” means including but not limited to and should be interpreted in the manner it is typically used in the patent context. Use of broader terms such as “comprises,” “includes,” and “having” should be understood to provide support for narrower terms such as “consisting of,” “consisting essentially of,” and “comprised substantially of.”

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, terms such as “front,” “rear,” “top,” etc. are used for explanatory purposes in the examples provided to describe the relative position of certain components or portions of components.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

Thus, particular embodiments of the subject matter have been described. While this specification contains many specific implementation details, these should not be construed as limitations on the scope of the present disclosure or of what may be claimed, but rather as description of features specific to particular embodiments of present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The following exemplary embodiments are provided, the numbering of which is not to be construed as designating levels of importance or relevance.

Embodiment 1 provides a mobile food transportation system comprising a food item housing chamber structured to support one or more food items; a humidity control chamber comprising an ambient air chamber separated from an extension chamber by a porous or perforated membrane, wherein the extension chamber is fluidly connected to the food item housing chamber and the ambient air chamber is fluidly connected with a surrounding environment of the mobile food transportation system; a first fan positioned between the extension chamber and the food item housing chamber; and a first vent positioned between the extension chamber and the food item housing chamber, wherein, during operation of the first fan, moisture is at least partially removed from moisture-laden air passing through the extension chamber.

Embodiment 2 provides the mobile food transportation system of Embodiment 1, further comprising a second fan positioned in the ambient air chamber; and a second vent positioned in the ambient air chamber, wherein the second fan and the second vent are configured to move ambient air from the surrounding environment across the porous or perforated membrane.

Embodiment 3 provides the mobile food transportation system of Embodiment 2, wherein the second fan is configured to operate as an air inlet to accept ambient air from the surrounding environment and the second vent is configured to operate as an air outlet to allow air to exit the ambient air chamber.

Embodiment 4 provides the mobile food transportation system of any one of Embodiments 1-3, wherein the second fan and the second vent are structured to create a low pressure zone in the ambient air chamber to draw moisture through the porous or perforated membrane from the extension chamber.

Embodiment 5 provides the mobile food transportation system of any one of Embodiments 1-4, wherein the first fan is configured to operate as an air inlet to accept moisture-laden air from the food item housing chamber and the first vent is configured to operate as an air outlet to allow air to reenter the food item housing chamber from the extension chamber.

Embodiment 6 provides the mobile food transportation system of any one of Embodiments 1-5, further comprising one or more air baffles disposed within the extension chamber, wherein the one or more air baffles are configured to obstruct flow of moisture-laden air through the extension chamber.

Embodiment 7 provides the mobile food transportation system of any one of Embodiments 1-6, wherein the porous or perforated membrane comprises a polypropylene sheet perforated with a plurality of holes.

Embodiment 8 provides the mobile food transportation system of Embodiment 7, wherein one or more holes of the plurality of holes have a diameter larger than 0.1 inches.

Embodiment 9 provides the mobile food transportation system of any one of Embodiments 1-8, further comprising one or more heating elements configured to impart heat to air within the food item housing chamber.

Embodiment 10 provides the mobile food transportation system of any one of Embodiments 1-9, further comprising a third fan positioned within the food item housing chamber, wherein the third fan is configured to circulate air heated by the one or more heating elements through the one or more food items.

Embodiment 11 provides the mobile food transportation system of any one of Embodiments 1-10, further comprising a food container cradle removably positioned within the food item housing chamber, wherein a third fan is positioned within the food container cradle.

Embodiment 12 provides the mobile food transportation system of Embodiment 11, wherein the food container cradle further comprises a rechargeable battery configured to supply power to the third fan when the food container cradle is removed from the food item housing chamber.

Embodiment 13 provides the mobile food transportation system of any one of Embodiments 1-12, further comprising a humidity sensor configured to determine a relative humidity within the food item housing chamber; and a controller in communication with the humidity sensor and the first fan, wherein the controller is configured to operate the first fan in response to the relative humidity satisfying a defined threshold.

Embodiment 14 provides the mobile food transportation system of any one of Embodiments 1-13, further comprising a temperature sensor configured to determine a temperature within the food item housing chamber, wherein the controller is further in communication with the temperature sensor and is configured to control one or more heating elements based on data received from the temperature sensor.

Embodiment 15 provides a method of controlling humidity in a mobile food transportation system, comprising receiving moisture-laden air from a food item housing chamber into an extension chamber of a humidity control chamber through a first opening between the food item housing chamber and the extension chamber; circulating the moisture-laden air through the extension chamber and along a porous or perforated membrane separating the extension chamber from an ambient air chamber; drawing ambient air from a surrounding environment through the ambient air chamber and across the porous or perforated membrane to create a low pressure zone that removes moisture from the moisture-laden air; and returning dehumidified air from the extension chamber to the food item housing chamber through a second opening between the extension chamber and the food item housing chamber.

Embodiment 16 provides the method of Embodiment 15, further comprising obstructing the flow of moisture-laden air within the extension chamber using one or more air baffles to increase exposure of the moisture-laden air to the porous or perforated membrane.

Embodiment 17 provides the method of any one of Embodiments 15-16, further comprising collecting excess moisture condensed from the moisture-laden air in a condensation collector positioned at a bottom of the extension chamber.

Embodiment 18 provides the method of any one of Embodiments 15-17, further comprising heating air within the food item housing chamber using one or more heating elements; and circulating the heated air through the one or more food items using a fan positioned within the food item housing chamber.

Embodiment 19 provides the method of any one of Embodiments 15-18, further comprising monitoring a relative humidity within the food item housing chamber using a humidity sensor; and adjusting a speed of one or more fans in response to the relative humidity satisfying a defined threshold.

Embodiment 20 provides the method of any one of Embodiments 15-19, further comprising monitoring a temperature within the food item housing chamber using a temperature sensor; and adjusting a heat output of one or more heating elements based on data received from the temperature sensor.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A mobile food transportation system comprising:
a food item housing chamber structured to support one or more food items;
a humidity control chamber comprising an ambient air chamber separated from an extension chamber by a porous or perforated membrane, wherein the extension chamber is fluidly connected to the food item housing chamber and the ambient air chamber is fluidly connected with a surrounding environment of the mobile food transportation system;
a first fan positioned between the extension chamber and the food item housing chamber, and
a first vent positioned between the extension chamber and the food item housing chamber,
wherein, during operation of the first fan, moisture is at least partially removed from moisture-laden air passing through the extension chamber.

2. The mobile food transportation system of claim 1, further comprising:
a second fan positioned in the ambient air chamber; and
a second vent positioned in the ambient air chamber, wherein the second fan and the second vent are configured to move ambient air from the surrounding environment across the porous or perforated membrane.

3. The mobile food transportation system of claim 2, wherein the second fan is configured to operate as an air inlet to accept ambient air from the surrounding environment and the second vent is configured to operate as an air outlet to allow air to exit the ambient air chamber.

4. The mobile food transportation system of claim 2, wherein the second fan and the second vent are structured to create a low pressure zone in the ambient air chamber to draw moisture through the porous or perforated membrane from the extension chamber.

5. The mobile food transportation system of claim 1, wherein the first fan is configured to operate as an air inlet to accept moisture-laden air from the food item housing chamber and the first vent is configured to operate as an air outlet to allow air to reenter the food item housing chamber from the extension chamber.

6. The mobile food transportation system of claim 1, further comprising:
one or more air baffles disposed within the extension chamber, wherein the one or more air baffles are configured to obstruct flow of moisture-laden air through the extension chamber.

7. The mobile food transportation system of claim 1, wherein the porous or perforated membrane comprises a polypropylene sheet perforated with a plurality of holes.

8. The mobile food transportation system of claim 7, wherein one or more holes of the plurality of holes have a diameter larger than 0.1 inches.

9. The mobile food transportation system of claim 1, further comprising:
one or more heating elements configured to impart heat to air within the food item housing chamber.

10. The mobile food transportation system of claim 9, further comprising:
a third fan positioned within the food item housing chamber, wherein the third fan is configured to circulate air heated by the one or more heating elements through the one or more food items.

11. The mobile food transportation system of claim 9, further comprising:
a food container cradle removably positioned within the food item housing chamber, wherein a third fan is positioned within the food container cradle.

12. The mobile food transportation system of claim 11, wherein the food container cradle further comprises a rechargeable battery configured to supply power to the third fan when the food container cradle is removed from the food item housing chamber.

13. The mobile food transportation system of claim 1, further comprising:
a humidity sensor configured to determine a relative humidity within the food item housing chamber; and
a controller in communication with the humidity sensor and the first fan, wherein the controller is configured to operate the first fan in response to the relative humidity satisfying a defined threshold.

14. The mobile food transportation system of claim 13, further comprising:
a temperature sensor configured to determine a temperature within the food item housing chamber, wherein the controller is further in communication with the temperature sensor and is configured to control one or more heating elements based on data received from the temperature sensor.

15. A method of controlling humidity in a mobile food transportation system, comprising:
receiving moisture-laden air from a food item housing chamber into an extension chamber of a humidity control chamber through a first opening between the food item housing chamber and the extension chamber;
circulating the moisture-laden air through the extension chamber and along a porous or perforated membrane separating the extension chamber from an ambient air chamber;
drawing ambient air from a surrounding environment through the ambient air chamber and across the porous or perforated membrane to create a low pressure zone that removes moisture from the moisture-laden air; and
returning dehumidified air from the extension chamber to the food item housing chamber through a second opening between the extension chamber and the food item housing chamber.

16. The method of claim 15, further comprising:
obstructing the flow of moisture-laden air within the extension chamber using one or more air baffles to increase exposure of the moisture-laden air to the porous or perforated membrane.

17. The method of claim 16, further comprising:
collecting excess moisture condensed from the moisture-laden air in a condensation collector positioned at a bottom of the extension chamber.

18. The method of claim 15, further comprising:
heating air within the food item housing chamber using one or more heating elements; and
circulating the heated air through the one or more food items using a fan positioned within the food item housing chamber.

19. The method of claim 15, further comprising:
monitoring a relative humidity within the food item housing chamber using a humidity sensor; and
adjusting a speed of one or more fans in response to the relative humidity satisfying a defined threshold.

20. The method of claim 15, further comprising:
monitoring a temperature within the food item housing chamber using a temperature sensor; and
adjusting a heat output of one or more heating elements based on data received from the temperature sensor.
